(19) United States
(12) Patent Application Publication
(10) Pub. No.: US 2023/0284795 A1
(43) Pub. Date: Sep. 14, 2023

(54) PLAYPEN CONNECTING JOINT AND PLAYPEN

(71) Applicant: Shenzhen Yingtuo Innovation Technology Co., Ltd., Shenzhen (CN)

(72) Inventors: Zidong Lin, Jieyang (CN); Gengjia Yang, Jieyang (CN)

(21) Appl. No.: 18/121,018

(22) Filed: Mar. 14, 2023

(30) Foreign Application Priority Data
Mar. 14, 2022 (CN) 2022205631096

(51) Int. Cl. A47D 13/06; F16B 12/40

(52) U.S. Cl. CPC A47D 13/066; F16B 12/40

(57) ABSTRACT

The invention discloses a playpen connecting joint and a playpen. The playpen connecting joint comprises a shell, a locking piece, a cover plate and a horizontal pipe connector. The locking piece is actuated through the cooperation of a lock catch and a push switch, so as to realize free rotation and fixation of the horizontal pipe connector, so that the playpen adopting the playpen connecting joint can realize free adjustment of the enclosure shape, and is stable in structure and easy to operate in use.

### BACKGROUND OF THE INVENTION

### 1. Technical Field

The invention relates to the technical field of playpens, in particular to a playpen connecting joint and a playpen.

### 2. Description of Related Art

Playpens play a very important role in infant care. They can free the hands of a guardian, protect infants, and assist in infant exercise in crawling and standing. Therefore, more and more guardians begin to use playpens.

Playpens in the prior art usually adopt a connector with a three-way structure to connect horizontal pipes and vertical pipes. Because the three-way structure itself is a fixed rigid part, the horizontal pipes and the vertical pipes connected by the three-way structure cannot rotate relative to each other, and as a result, the playpen adopting this scheme cannot realize enclosure shape change as needed.

In order to change the enclosure shape of a playpen as needed, U.S. patent No. US20180110344A1 discloses a horizontal universal joint, which comprises a first joint component and a second joint component, wherein the first joint component is integrally formed by a frame insertion port and a female coupling port, and the second joint component is integrally formed by a frame insertion port and a male coupling port. The female coupling port of the first joint component and the male coupling port of the second joint component are detachably connected by an elastic body, and tooth rows formed on an inner peripheral surface of the female coupling port and an outer peripheral surface of the male coupling port mesh with each other. When the male coupling port is inserted into the female coupling port, the horizontal direction of the frame insertion port of the second joint component relative to the frame insertion port of the first joint component is variable according to the meshing position of the two tooth rows.

Although the playpen adopting this scheme can be rotated into any shape, the playpen cannot be effectively fixed in an enclosed state. The rotation and fixation of the horizontal universal joint are realized through a rack and a tooth socket, but no rotation locking and releasing mechanism is provided, so the resistance between the rack and the tooth socket can only be overcome through violent rotation. The repetition of such operation will seriously wear the rack, and as a result, the joint will gradually lose its positioning ability after rotation, which further leads to the failure to effectively fix the enclosure shape and the failure to realize effective fixation after folding too, thus seriously affecting user experience.

In view of the above technical problems, it is necessary to provide a playpen connecting joint which can fix an enclosed state or folded state of a playpen. The playpen connecting joint can lock the playpen to prevent it against unnecessary rotation, and can also release the locked state of the playpen, so that the enclosure shape of the playpen can be changed as needed, and a rotation limiting mechanism of the playpen connector will not be worn during the rotation of the playpen. Besides, the playpen connector is easy to operate, and long in service life.

### BRIEF SUMMARY OF THE INVENTION

The invention provides a playpen connecting joint, comprising a shell, a locking piece, a cover plate and a horizontal pipe connector, wherein the shell comprises an opening, a socket and a boss, and the boss is provided with a push switch and sleeved with a spring; the locking piece comprises a sleeve and a locking ring, the sleeve is disposed around the boss and provided with a lock catch which can touch the push switch, and internal teeth are formed on the locking ring; a mandrel is formed on the cover plate, and the mandrel is disposed inside the socket; and the horizontal pipe connector is disposed around the mandrel and axially rotates along the mandrel through the opening, and the horizontal pipe connector further comprises a gear meshing with the internal teeth of the locking ring.

According to the playpen connecting joint provided by the invention, by actuating the locking piece and compressing the spring, the lock catch is inserted into the push switch, and the locking ring is separated from the gear on the horizontal pipe connector, so that the horizontal pipe connector rotates; and by actuating the locking piece (2) again, the lock catch (11) is separated from the push switch (5), the spring (6) will reset and push up the locking ring (10), and the locking ring (10) will mesh with the gear (12) to fix the horizontal pipe connector (4).

The invention also provides a playpen, which comprises horizontal pipes, vertical pipes and the playpen connecting joints as mentioned above.

### BRIEF DESCRIPTION OF THE SEVERAL VIEWS OF THE DRAWINGS

In order to explain the technical scheme of the application more clearly, the drawings used in the embodiments will be briefly introduced below. Obviously, the drawings in the following description only illustrate some embodiments of the application, and for those of ordinary skill in the field, other drawings can be obtained according to these drawings without creative labor.

FIG. 1 is a perspective view of a playpen connecting joint of the invention in an unlocked and adjustable state;

FIG. 2 is a perspective view of the playpen connecting joint in FIG. 1 which is partially cut open;

FIG. 3 is a perspective view of a playpen connecting joint of the invention in a locked and non-adjustable state;

FIG. 4 is a perspective view of the playpen connecting joint in FIG. 3 which is partially cut open;

FIG. 5 is an exploded perspective view of the playpen connecting joint in FIG. 4 which is partially cut open;

FIG. 6 is an exploded perspective view of the playpen connecting joint in FIG. 1;

FIG. 7 is a perspective view of a playpen of the invention;

FIG. 8 is an enlarged view of A in FIG. 7;

FIG. 9 is an enlarged view of B in FIG. 7; and

FIG. 10 is an enlarged view of C in FIG. 7.

In the drawings:

1, shell; 2, locking piece; 3, cover plate; 4, horizontal pipe connector; 5, push switch; 6, spring; 7, button; 8, boss; 9, sleeve; 10, locking ring; 11, lock catch; 12, gear; 13, horizontal pipe joint; 14, vertical pipe joint; 15, mandrel; 16, opening; 17, socket; 18, pipe connection snap joint; 19, sucker; 20, sliding part; 21, sliding shoulder; 22, horizontal pipe; 23, vertical pipe.

### DETAILED DESCRIPTION OF THE INVENTION

The technical solution in the embodiments of the application will be described clearly and completely with reference to the drawings in the embodiments of the application. Obviously, the embodiments in the following description are merely illustrative ones, and are not possible ones of the application. All other embodiments obtained by those of ordinary skill in the art based on the embodiments in this application without creative labor fall within the protection scope of this application.

Reference to an “embodiment” or “implementation” herein means that a particular feature, structure or characteristic described in connection with the embodiment or implementation may be included in at least one embodiment of the application. The appearance of this phrase in various places in the specification does not necessarily mean the same embodiment, nor is it an independent or alternative embodiment mutually exclusive with other embodiments. Those skilled in the art understand explicitly and implicitly that the embodiments described herein can be combined with other embodiments.

In this specification, for the sake of convenience, words indicating orientation or positional relationship such as “middle”, “upper”, “lower”, “front”, “rear”, “vertical”, “horizontal”, “top”, “bottom”, “inner” and “outer” are used to illustrate the positional relationship of constituent elements with reference to the attached drawings. These words are only for the convenience of describing this specification and simplifying the description, and do not indicate or imply that the devices or elements referred to must have a specific orientation, or be constructed and operated in a specific orientation, so they cannot be understood as limitations of this disclosure. The positional relationship of the constituent elements can be appropriately changed according to the direction of the described constituent elements. Therefore, the invention is not limited to the words and expressions described in the specification, and appropriate change can be made according to the situation.

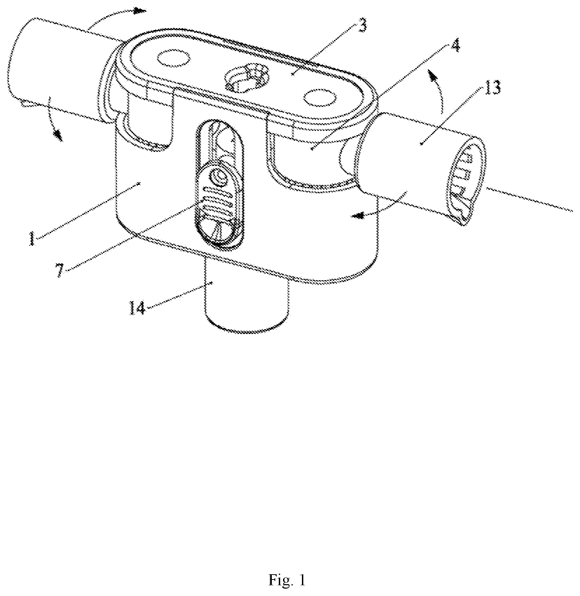

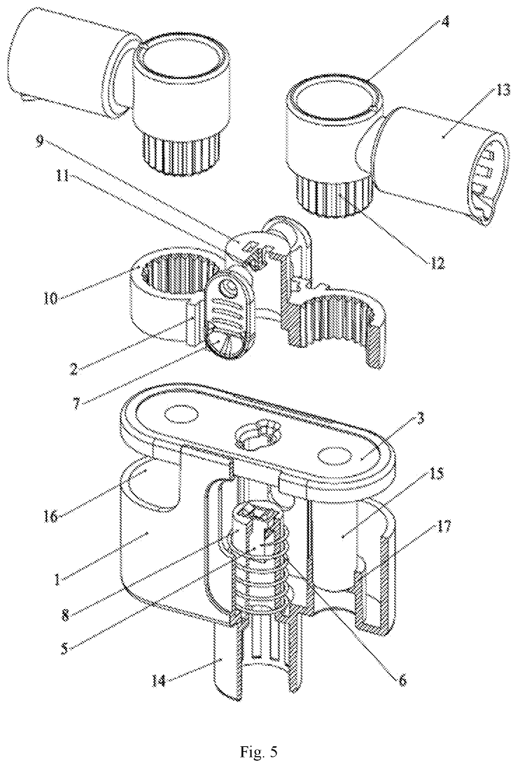

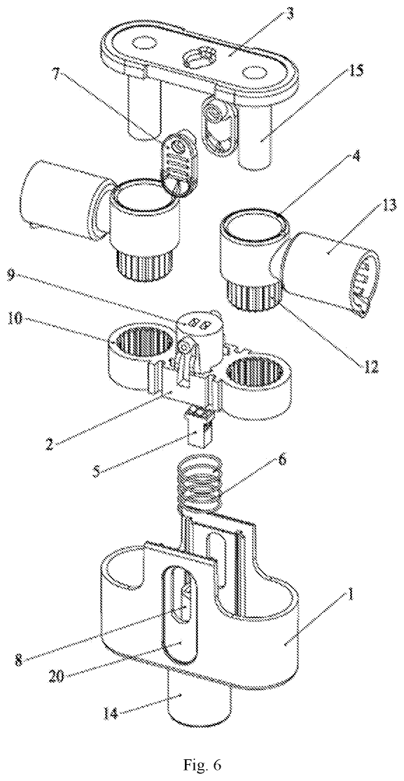

As shown in FIGS. 1-6, a playpen connecting joint provided by the invention comprises a shell 1, a locking piece 2, a cover plate 3 and a horizontal pipe connector 4.

As shown in FIGS. 1-6, the shell 1 comprises an opening 16, a socket 17 and a boss 8, and the boss 8 is provided with a push switch 5 and sleeved with a spring 6; the locking piece 2 comprises a sleeve 9 and a locking ring 10, the sleeve 9 is disposed around the boss 8 and provided with a lock catch 11 which can touch the push switch 5, and internal teeth are formed on the locking ring 10; a mandrel 15 is formed on the cover plate 3, and the mandrel 15 is disposed inside the socket 17; and the horizontal pipe connector 4 is disposed around the mandrel 15 and axially rotates along the mandrel 15 through the opening 16, and the horizontal pipe connector 4 further comprises a gear 12 meshing with the internal teeth of the locking ring 10.

When the horizontal pipe connector 4 needs to rotate, by actuating the locking piece 2 and compressing the spring 6, the lock catch 11 is inserted into the push switch 5, and the locking ring 10 is separated from the gear 12 on the horizontal pipe connector 4, so that the horizontal pipe connector 4 can rotate freely.

When the horizontal pipe connector 4 needs to be fixed, by actuating the locking piece 2 again, the lock catch 11 is separated from the push switch 5, the spring 6 will reset and push up the locking ring 10, and the locking ring 10 will mesh with the gear 12 to fix the horizontal pipe connector 4.

In this embodiment, the opening 16 provides a rotating space for the horizontal pipe connector 4, so that the horizontal pipe connector 4 disposed inside the shell 1 can freely rotate relative to the shell 1. The spring 6 is configured to abut against the bottom of the shell 1 and the bottom of the sleeve 9. When the lock catch 11 on the locking piece 2 is inserted into the push switch 5, the spring 6 will be compressed. When the lock catch 11 on the locking piece 2 is separated from the push switch 5, the elastic potential energy of the compressed spring 6 will further push the locking piece 2 to move, so that the locking ring 10 on the locking piece 2 can be completely separated from the gear 12, and finally the horizontal pipe connector 4 can rotate freely.

In some embodiments, the spring 6 may be other elastic members, including but not limited to elastic sheets.

In this embodiment, the push switch 5 can fix and release the lock catch 11 inserted therein, and in other embodiments, the push switch 5 can adopt other structures, as long as it can fix and release the lock catch 11, so as to allow the locking ring 10 to be separated from and mesh with the gear 12.

As a preferred embodiment of the invention, in order to allow a user to operate the playpen connecting joint easily, the playpen connecting joint is also provided with a button 7, the button 7 is fixedly connected to the locking piece 2, and the user can make the locking piece 2 mesh with or separated from the gear 12 by actuating the button 7, so as to change the usage state of the horizontal pipe connector 4.

In order to facilitate the actuation of the button 7, the shell 1 is provided with a sliding part 20 for the button 7 to slide on, the sliding part 20 defines a sliding path of the button 7, so that the button 7 can slide more smoothly, and at the same time, a displacement path of the locking piece 2 can be limited to prevent the locking piece 2 from breaking down during displacement.

In order to make the rotation of the horizontal pipe connector 4 more stable and smooth, the cover plate 3 is provided with a sliding shoulder 21, which provides a rotation path of the horizontal pipe connector 4, so that the rotation of the horizontal pipe connector 4 is more stable and smooth.

In this embodiment, two mandrels 15 are formed on the cover plate 3, and two sockets 17 are formed on the shell 1 correspondingly. The mandrels 15 are disposed inside the sockets 17 respectively, and the sockets 17 can position the cover plate 3. Similarly, the sockets 17 can also position the horizontal pipe connector 4 and the locking ring 10 disposed around the mandrels 15, which makes the structure of the playpen connecting joint more stable and reasonable, and greatly reduces the failure rate in actual use.

As a preferred embodiment of the invention, in order to facilitate the insertion of playpen pipes, the horizontal pipe joint 13 of the horizontal pipe connector 4 is provided with a pipe connection snap joint 18, which can stably fix the playpen pipes connected therein, and the user can conveniently and quickly disassemble the playpen pipes through the pipe connection snap joint 18.

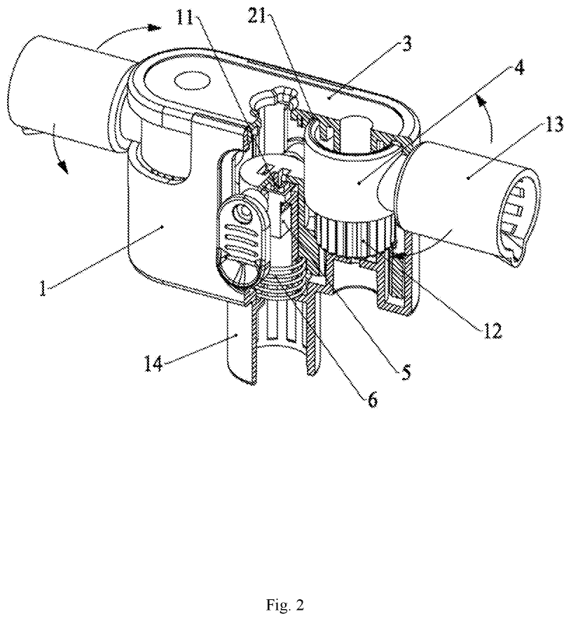

In use, as shown in FIGS. 1 and 2, the user can press the button 7 with both hands and push the button 7 down to the bottom of the sliding part 20. At this point, the locking piece 2 will be unlocked, and the horizontal pipe connector 4 can rotate freely.

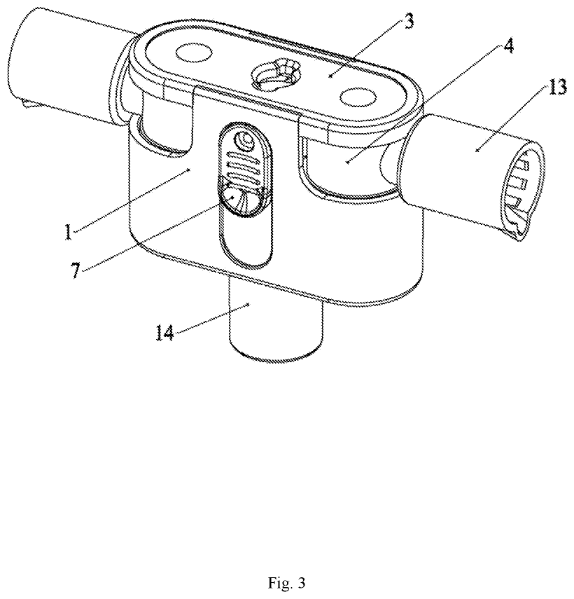

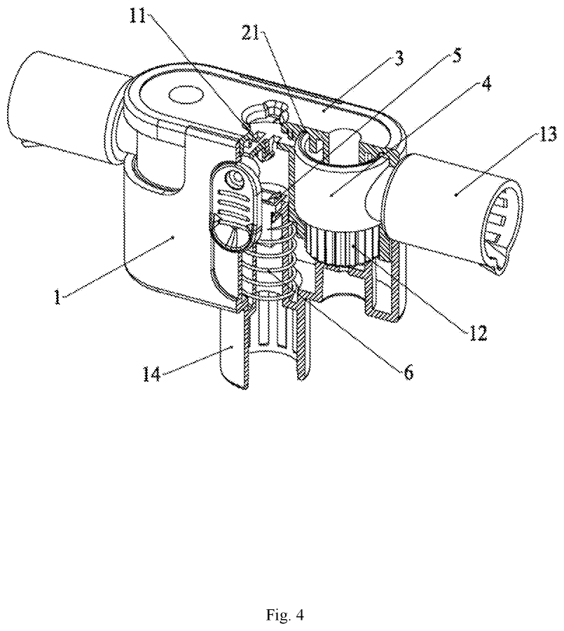

As shown in FIGS. 3 and 4, when the button 7 is pushed down again, the lock catch 11 will be separated from the push switch 5, and the locking piece 2 will be locked. At this point, the horizontal pipe connector 4 will also be locked and cannot rotate.

In this embodiment, the bottom of the shell 1 is also provided with a vertical pipe joint 14, which is also configured to receive playpen pipes. The vertical pipe joint 14 can also be provided with a pipe connection snap joint 18 the same as that of the horizontal pipe joint 13 to facilitate the disassembly and assembly of playpen pipes, and the vertical pipe joint 14 and the horizontal pipe joint 13 can form a three-way pipe connecting joint to facilitate usage.

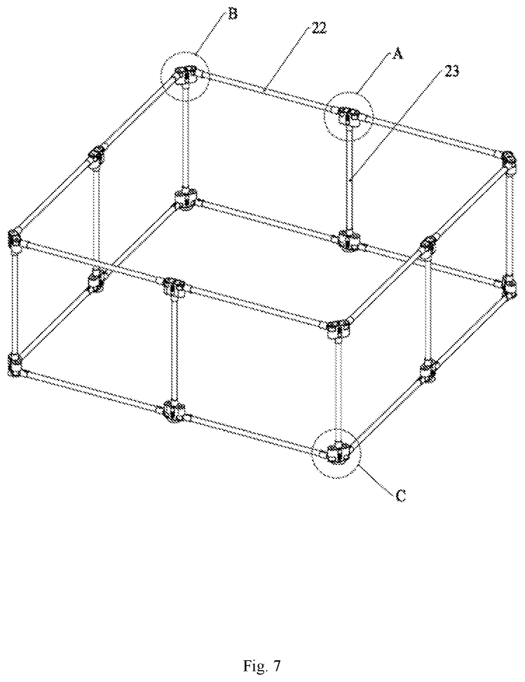

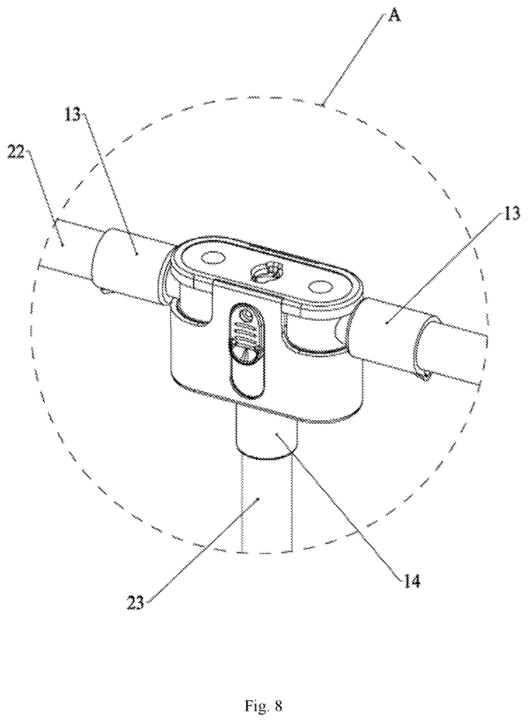

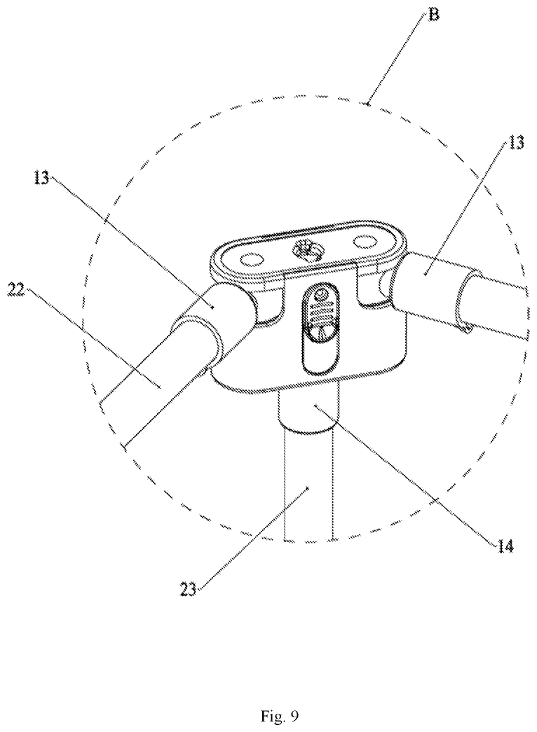

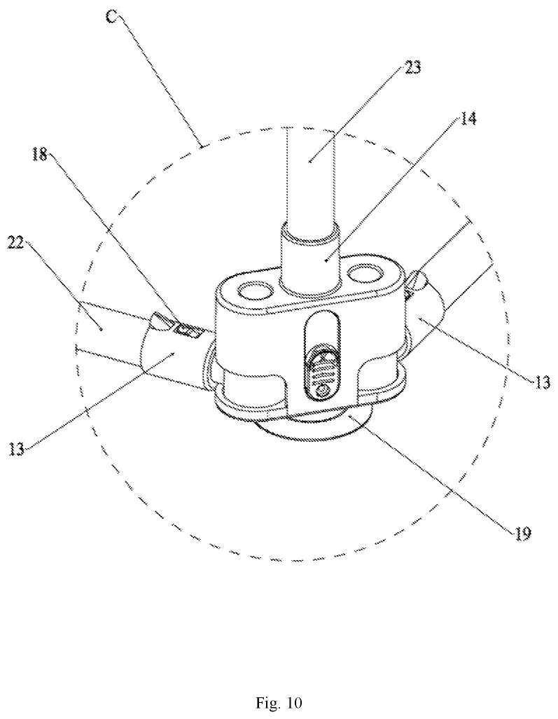

As shown in FIGS. 7-10, the invention also provides a playpen, which adopts the playpen connector mentioned above, and further comprises horizontal pipes 22, vertical pipes 23 and playpen connecting joints for connecting the horizontal pipes and the vertical pipes.

The playpen connecting joint comprises an upper playpen connecting joint and a lower playpen connecting joint. In this embodiment, a cover plate of the lower playpen connecting joint is provided with a sucker 19, which can increase the stability of the playpen on the ground. In other embodiments, the cover plate of the lower playpen connecting joint can also be provided with a foot pad (not shown in the figure), which can also increase the stability of the playpen on the ground.

According to the invention, the rotation and fixation of the horizontal pipe connector 4 are realized through the meshing of a gear ring and a gear, locking and unlocking are easy and efficient, and the overall structure is stable; each horizontal pipe connector can freely rotate around its own mandrel, and the angle between different horizontal pipe connectors can be freely adjusted without any direction limitation; and various polygonal playpens or even playpens in a nearly circular shape can be installed without restriction, the occupied space is extremely small after the playpen is folded, and the playpen does not need to be installed again when used next time, and only needs to be unfolded.

The technical means disclosed in the scheme of the invention are not limited to the technical means disclosed in the above embodiments, but also include technical schemes involving any combination of the above technical features. It should be noted that several improvements or embellishments made by those of ordinary skill in the art without departing from the principles of the invention should also be regarded as falling the scope of protection of the invention.

What is claimed is:

1. A playpen connecting joint, comprising a shell, a locking piece, a cover plate and a horizontal pipe connector, wherein
the shell comprises an opening, a socket and a boss, and the boss is provided with a push switch and sleeved with a spring;
the locking piece comprises a sleeve and a locking ring, the sleeve is disposed around the boss and provided with a lock catch which can touch the push switch, and internal teeth are formed on the locking ring;
a mandrel is formed on the cover plate, and the mandrel is disposed inside the socket;
the horizontal pipe connector is disposed around the mandrel and axially rotates along the mandrel through the opening, and the horizontal pipe connector further comprises a gear meshing with the internal teeth of the locking ring;
by actuating the locking piece and compressing the spring, the lock catch is inserted into the push switch, and the locking ring is separated from the gear on the horizontal pipe connector, so that the horizontal pipe connector rotates;
by actuating the locking piece again, the lock catch is separated from the push switch, the spring will reset and push up the locking ring, and the locking ring will mesh with the gear to fix the horizontal pipe connector; and
a three-way pipe connecting joint of a playpen formed by a pipe joint of the horizontal pipe connector and a vertical pipe joint of the shell is further provided.

2. The playpen connecting joint according to claim 1, further comprising a button, wherein the button is fixedly connected to the locking piece.

3. The playpen connecting joint according to claim 1, wherein a sliding part is formed on the shell, and the sliding part defines a sliding path of the button.

4. The playpen connecting joint according to claim 1, wherein the cover plate is provided with a sliding shoulder, and the sliding shoulder provides a sliding channel for the horizontal pipe connector.

5. The playpen connecting joint according to claim 1, wherein the locking ring and the socket form a nested positioning structure.

6. The playpen connecting joint according to claim 1, wherein the pipe joint of the horizontal pipe connector is provided with a pipe connection snap joint.

7. A playpen, comprising horizontal pipes, vertical pipes and playpen connecting joints for connecting the horizontal pipes and vertical pipes, wherein the playpen connecting joint comprises a shell, a locking piece, a cover plate and a horizontal pipe connector,
the shell comprises an opening, a socket and a boss, and the boss is provided with a push switch and sleeved with a spring;
the locking piece comprises a sleeve and a locking ring, the sleeve is disposed around the boss and provided with a lock catch which can touch the push switch, and internal teeth are formed on the locking ring;
a mandrel is formed on the cover plate, and the mandrel is disposed inside the socket;
the horizontal pipe connector is disposed around the mandrel and axially rotates along the mandrel through the opening, and the horizontal pipe connector further comprises a gear meshing with the internal teeth of the locking ring;
by actuating the locking piece and compressing the spring, the lock catch is inserted into the push switch, and the locking ring is separated from the gear on the horizontal pipe connector, so that the horizontal pipe connector rotates;
by actuating the locking piece again, the lock catch is separated from the push switch, the spring will reset and push up the locking ring, and the locking ring will mesh with the gear to fix the horizontal pipe connector; and
a three-way pipe connecting joint of the playpen formed by a pipe joint of the horizontal pipe connector and a vertical pipe joint of the shell is further provided.

8. The playpen according to claim 7, wherein the playpen connecting joint comprises an upper playpen connecting joint and a lower playpen connecting joint, and a cover plate of the lower playpen connecting joint is provided with a sucker.

9. The playpen according to claim 8, wherein the playpen connecting joint comprises an upper playpen connecting joint and a lower playpen connecting joint, and the cover plate of the lower playpen connecting joint is provided with a foot pad.
